(19) United States
(12) Patent Application Publication
(10) Pub. No.: US 2017/0295752 A1
(43) Pub. Date: Oct. 19, 2017

(54) Animal Nursing System

(71) Applicant: Joseph R. Evans, Clifton, CO (US)

(72) Inventor: Joseph R. Evans, Clifton, CO (US)

(21) Appl. No.: 15/471,999

(22) Filed: Mar. 28, 2017

Related U.S. Application Data
(60) Provisional application No. 62/314,124, filed on Mar. 28, 2016.

(51) Int. Cl. A01K 9/00

(52) U.S. Cl. CPC A01K 9/005

(57) ABSTRACT

An animal nursing system for feeding orphaned baby animals is provided. The baby animals having a mother animal with a particular torso shape, The animal nursing system comprises an outer cover having an inner surface and an outer surface with the outer cover molded to the torso shape of the mother animal. A liquid holding main bladder is enclosed within the outer cover. At least one teat is mounted to the outer surface of the cover with the at least one teat in fluid communication with the main bladder. Upon the main bladder being filled with the liquid, the main bladder expands against the inner surface of the outer cover causing the outer cover to expand to a maximum expansion size and upon the liquid emptying from the main bladder, the main bladder contracts to a minimum contraction size. The outer cover maintains the torso shape of the mother animal at both the maximum and minimum sizes.

### CLAIM OF PRIORITY

This patent application claims priority under 35 USC 119 (e)) from U.S. Provisional Patent Application Ser. No. 62/314,124 filed Mar. 28, 2016, of common inventorship herewith entitled, “Breeder's Feeder Surrogate Mother,” which is incorporated herein by reference as though the same were set forth in its entirety.

### FIELD OF THE INVENTION

The present invention pertains to the field of animal nursing systems, and more specifically to the field of animal nursing systems configured specifically for feeding orphaned baby animals.

### BACKGROUND OF THE INVENTION

Pets provide unconditional love, companionship and unmatched loyalty to their owners. Providing protection and happy companionship, a dog is known as man's best friend and although independent, a cat provides love and warmth to an owner. For many pet owners, a favorite end to a hectic day is spent curled up on a sofa or chair with a beloved pet nestled nearby. To provide loving homes for animals in need, many caring animal lovers adopt new pets from animal shelters and rescue organizations as opposed to purchasing pets from pet shops or breeders.

Kittens and puppies often are abandoned or orphaned at a very early age before being weaned from their mothers. A caring pet owner must nurse the animal manually by feeding it nourishing milk means of a nursing bottle. Affectionately known by rescuers as bottle babies, these puppies and kittens require extra love and care if they are to survive. There are many other baby animals besides puppies and kitties that require bottle feeding, especially on farms or in facilities where live stock are cared for and raised.

The prior art has put forth several designs for nursing equipment for suckling mammals. Among these are:

U.S. Pat. No. 6,854,420 to Graham Stuart Crocker describes a device for delivering liquid to livestock particularly birds such as poultry and game bird. The device comprises a container for holding liquid. The container is suspendable within a livestock feeding area. The container has a plurality of nipples arranged on a lower surface of the container such that livestock can drink liquid from within the container by means of the nipples.

U.S. Pat. No. 6,752,103 to Fay Howell describes an infant animal nursing device comprising a mock animal resembling a mother of an infant animal and having a washable exterior surface comprised of fur material. The mock animal is in a reclined feeding position exposing an underbelly and allowing access to feeding nipples therein. The reclined feeding position encompasses infant animals in a protective manner. An interior cavity is formed in the underbelly and is accessible through a longitudinal opening formed along a longitudinal axis of the underbelly. A nursing assembly is retained in the cavity with the nursing assembly having a plurality of bottles corresponding to a plurality of nursing nipples available for a plurality of infant animals. An internal heating pad, retained in the aforementioned cavity posterior to the nursing assembly, is thermostatically controlled for warming the nursing assembly an fluid contained thereby. A means for simulating a heartbeat is contained within the cavity and is audibly transmitted through stereo speakers placed within the mock mother.

U.S. Pat. No. 5,188,061 to Diane F. Lombardi describes a pet and animal feeder which provides small pets and animals with nursing means within a surrounding soft material. The present invention provides a container with a plurality of nipples, hollow protuberances simulating the teats depending from a mother. The container is tinned in a cavity within a stuffed cushion having an external shape similar to the adult version of the mammal for which the invention is being used. The nippled protuberances protrude from the cushion, through apertures in the cushion, and are available for suckling by the newborns.

None of these prior art references describe the present invention.

### SUMMARY OF THE INVENTION

It is an object of the present invention to provide an animal nursing system configured specifically for feeding orphaned baby animals.

The present invention is an animal nursing system for feeding orphaned baby animals. The baby animals are a particular species and breed with each particular species and breed has a mother animal with a particular torso shape and a particular teat shape. The animal nursing system comprises an outer cover having an inner surface and an outer surface with the outer cover molded to the torso shape of the mother animal. A main bladder is enclosed within the outer cover with the bladder holding a predetermined amount of liquid. At least one teat is mounted to the outer surface of the cover with the at least one teat in fluid communication with the main bladder and the teat molded to the teat shape of the mother animal. Upon the main bladder being filled with the liquid, the main bladder expands against the inner surface of the outer cover causing the outer cover to expand to a maximum expansion size and upon the liquid emptying from the main bladder, the main bladder contracts allowing the outer cover to contract to a minimum contraction size. The outer cover maintains the torso shape of the mother animal at both the maximum expansion size and the minimum contraction size.

In addition, the present invention further includes a method for feeding orphaned baby animals. The baby animals are a particular species and breed with each particular species and breed having a mother animal with a particular torso shape and a particular teat shape. The method comprises providing an outer cover having an inner surface and an outer surface, molding the outer cover to the torso shape of the mother animal, enclosing a main bladder within the outer cover, filling the bladder with a predetermined amount of liquid, mounting at least one teat to the outer surface of the cover, molding the teat to the teat shape of the mother animal, fluidly communicating the at least one teat with the main bladder, expanding the rain bladder against the inner surface of the outer cover causing the outer cover to expand to a maximum expansion size, contracting the main bladder allowing the outer cover to contract to a minimum contraction size, and maintaining the outer cover in the torso shape of the mother animal at both the maximum expansion size and the minimum contraction size.

The present invention further includes an animal nursing system for feeding orphaned baby animals. The baby animals are a particular species and breed with each particular species and breed having a mother animal with a particular torso shape and a particular teat shape. The animal nursing system comprises an outer cover having an inner surface and an outer surface with the outer cover molded to the torso shape of the mother animal. A main bladder is enclosed within the outer cover with the bladder holding a predetermined amount of liquid. At least one teat is mounted to the outer surface of the cover with the at least one teat in fluid communication with the main bladder and the teat molded to the teat shape of the mother animal. A closable pouch formed on the outer surface of the outer cover and a heating pad positionable in the pouch. The heating pad is capable of heating the liquid within the main bladder and the outer surface of the outer cover. Upon the main bladder being filled with the liquid, the bladder expands against the inner surface of the outer cover causing the outer cover to also expand to a maximum expansion size and upon the liquid emptying from the bladder, the bladder contracts allowing the outer cover to contract to a minimum contraction size. The main bladder is able to contract away from the inner surface of the outer cover when the outer cover reaches the minimum contraction size. The outer cover maintains the torso shape of the mother animal at both the maxim um expansion size and the minimum contraction size.

### BRIEF DESCRIPTION OF THE DRAWINGS

FIG. 1 is an elevational front view illustrating an animal nursing system, constructed in accordance with present invention, showing a support base, a torso-shaped outer cover enclosing an expandable bladder, hook and loop fasteners for releasably securing the outer cover to the support base, a fill valve formed in the outer cover for filling the bladder, and rows of teats mounted to the bladder.

FIG. 2 is a perspective view illustrating the animal nursing system, constructed in accordance with the present invention showing the support base, the torso-shaped outer cover enclosing the expandable bladder, the hook and loop fasteners, and the rows of teats.

FIG. 3 is a perspective view illustrating the animal nursing system, constructed in accordance with the present invention, showing the support base, the torso-shaped outer cover enclosing the expandable bladder, the hook and loop fasteners, the fill valve, and the rows of teats.

FIG. 4 is a top plan sectional view illustrating the bottom row of teats of the animal nursing system, constructed in accordance with the present invention, showing individual sub bladders and the baffle mechanism.

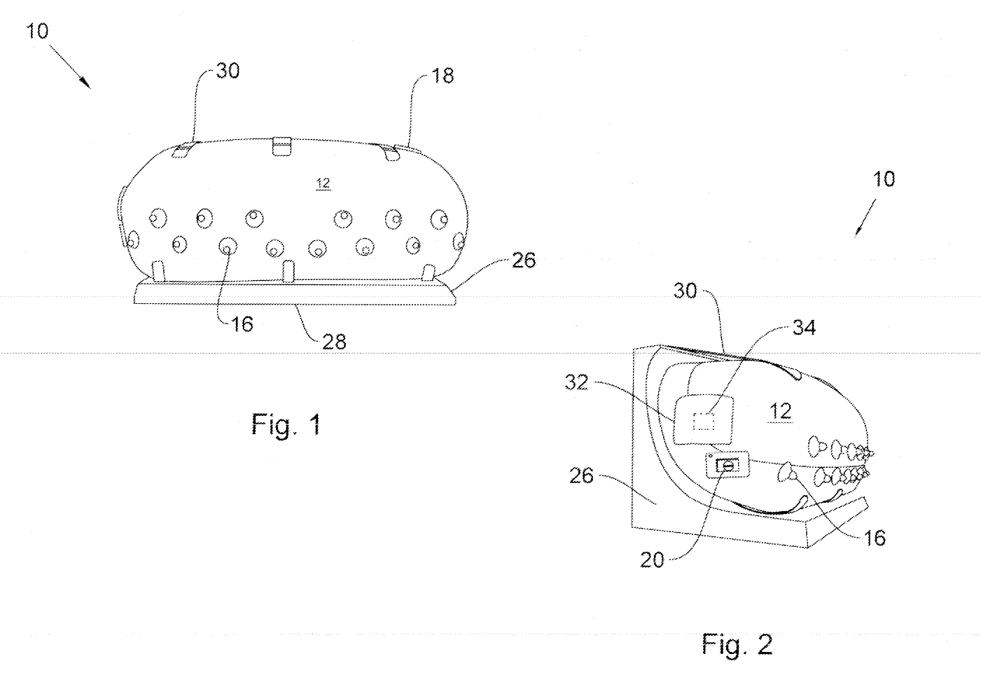

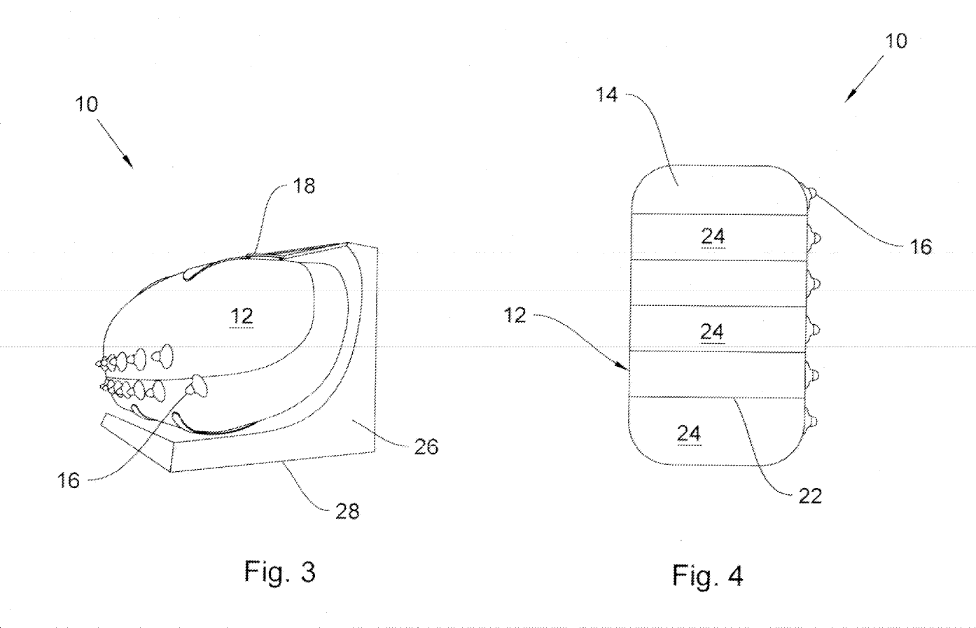

### DETAILED DESCRIPTION OF THE INVENTION

The present invention, hereinafter referred to as an Animal Nursing System, indicated generally at 10, is a nursing system configured specifically for feeding orphaned baby animals. The Animal Nursing System 10 provides pet owners, farmers, veterinarians, and similar animal care providers with a simple means of simultaneously nursing multiple baby puppies, kittens, and other abandoned baby animals. The Animal Nursing System 10 is highly effective in feeding or supplementing any suckling mammal including baby domestics, livestock, bred, or rescued baby animals.

The Animal Nursing System 10 of the present invention includes an outer cover 12 having an inner surface and an outer surface The outer cover 12 is molded to the shape of a torso of a mother animal. The outer cover 12 is constructed from a relatively firm, yet resilient, soft material which can expand and contract while still maintaining the torso shape in both the expanded and contracted condition. A preferred material for constructing the outer cover 12 is a rubber or rubber-based material although constructing the outer cover 12 from other materials are within the scope of the present invention.

Preferably, the outer cover 12 of the Animal Nursing System 10 of the present invention has contracted dimensions measuring approximately sixteen (6″) inches in length, eight (8″) inches in width, and eight (8″) inches in depth with comparable embodiments measuring different sizes to accommodate different animals' sizes. In certain embodiments, the outer cover 12 of the Animal Nursing System 10 has an expandable circumference of approximately twenty seven (27′) inches to approximately twenty eight (28″) inches.

As stated, the outer cover 12 of the Animal Nursing System 10 of the present invention is cast molded to simulate exactly a shape of a torso and teats of a lactating animal in both the expanded condition and the contracted condition. The outer cover 12 can be constructed in a variety of animal configurations including dogs, cats, rabbits, squirrels, livestock, and virtually any other suckling mammal.

In addition, the Animal Nursing System 10 of the present invention includes a bladder 14 fillable with animal's milk or milk substitute. Preferably, the bladder 14 is completely enclosed within the outer cover 12. As the bladder 14 is filled with the milk or milk substitute, the bladder 14 expands against the inner surface of the outer cover 12 causing the outer cover 12 to also expand to the maximum expansion size, as described above. As the milk or milk substitute is emptied from the bladder 14, the bladder 14 will contract allowing the outer cover 12 to contract to a minimum contraction size. The bladder 14 is constructed from a rubber or other resilient material such that the bladder 14 is able to continue contracting away from the inner surface of the outer cover 12 when the outer cover 12 reaches the minimum contraction size.

The Animal Nursing System 10 of the present invention additionally includes a plurality of teats 16 fluidly connected to the bladder 14 and extending through the outer cover 12. In a preferred embodiment, the front of the Animal Nursing System 10 includes approximately fifteen teats 16 in which the ends comprise replaceable nipple dispense through which the actual milk or milk substitute contained within the bladder 14 component is dispensed by means of the sucking action of the animal. Preferably, the teats 16 are arranged in two proximate rows, with one row of approximately seven teats 16 placed above a second row of approximately eight teats 16. The teats 16 are placed in spaced intervals to comfortably accommodate multiple suckling babies. Further, preferably, the teats 16 can include either vented or ion-vented rubber stoppers to inhibit leaking.

Furthermore, the Animal Nursing System 10 of the present invention at least one top fill port 18 with a cap threadably securable to the top fill port 18. The top fill port 18 is connected to the bladder 14 through the outer cover 1 2 and contains a sturdy threaded cap for sealing the valve in a closed position after filling the bladder 14 with liquid. Preferably, the top fill port 18 is vented allowing air inflow to promote the free flow of milk or milk substitute through the teats 16 upon the suckling of the baby animals.

Further yet, the Animal Nursing System 10 of the present invention includes a side fill port 20 having a cap threadably securable to the side fill port 20. Like the top fill port 18, the side fill port 20 can be vented allowing air inflow.

The Animal Nursing System 10 of the present invention includes a baffle mechanism 22 within the bladder 14 for controlling and regulating the flow of liquid through the bladder 14 and the teats 16, preventing the animals from ingesting air or taking in too much liquid. In an embodiment, the Animal sing System 10 includes a single bladder 14 completely filling the space within the outer corer 12. In another embodiment, the Animal Nursing System 10 includes a plurality of sub bladders 24, a single sub bladder 24 associated with a single teat 16 with the baffle mechanism 22 controlling the flow to each sub bladder 24. For instance, when filling the bladder 14 with the milk or milk substitute, each of the sub bladders 24 will fill completely. As the milk or milk substitute is removed from the sub bladders 24 through the respective teat 16, due to the baffle mechanism 22, the infant animal will only be able to access the milk or milk substitute in the sub bladder 24 associated with the particular teat 16. Once the milk or milk substitute is gone from the sub bladder 24, then the infant animal will not be able to access any additional milk or milk substitute from any other sub bladder 24 allowing the other infant animals to get their fair share.

In order to maintain stability and to secure the milk-filled outer cover 12 and bladder 14 in an upright position during use of the Animal Nursing System 10 of the present invention, a base 26 having a flat bottom surface 28 is provided. A plurality of hook and loop fasteners 30 are provided on the base 26 and the outer cover 12 to releasably secure the outer cover 12 to the base 26 providing the necessary structural integrity.

The Animal Nursing System 10 of the present invention further includes a pouch 32 formed on the outer surface 12 for receiving a heating pad 34. The heating pad 34 is engineered expressly to keep milk contained within the bladder 14 warmed to optimal temperature and to heat the surface of the outer cover 12. The pouch 32 can be releasably securable to maintain the heating pad 34 therein. The heating pad 34 can be powered by rechargeable battery or an electrical outlet.

Use of the Animal Nursing System 10 of the present invention is very simple and straightforward. An animal caregiver purchases the Animal Nursing System 10 in accordance to the designated animal breed. The user sets the Animal Nursing System 10 in the appropriate area side or outside the home. Connecting the included heating pad 34 to a standard power outlet, the user inserts the heating pad 34 into a dedicated pouch 32 incorporated into the outer cover 12 of the present invention.

The user prepares a milk or other nutritional formula and then pours the liquid directly into the Animal Nursing System 10 by means of the integrated fill valve 18. With the bladder 14 filled to capacity, the liquid flows through the individual teats 16 and the baby animals suckle side by side from the teats 16 as if feeding from their mother. As the baby animals suckle from the Animal Nursing System 10, the integrated baffle mechanism 22 controls the flow of liquid through the teats, preventing the animals from ingesting aft or taking in too much liquid.

The Animal Nursing System 10 of the present invention accommodates up to approximately fifteen nursing animals simultaneously, enabling a user to feed all animals in a litter in an expeditious manner. Containing an integral heating pad component, the present invention provides a sense of comfort and familiarity to any baby suckling mammal during an early transitional stage. The Animal Nursing System 10 also functions as a supplemental feeder in cases where the mother animal is unable to produce enough milk for her litter. The Animal Nursing System 10 is highly effective for use by pet owners and breeders as well as facilities who raise or care for livestock or rescued wildlife. Simple to use and durably constructed, the Animal Nursing System 10 will withstand years of continued use with ease.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An animal nursing system for feeding orphaned baby animals, the baby animals being a particular species and breed, each particular species and breed having a mother animal with a particular torso shape and a particular teat shape, the animal nursing system comprising:
an outer cover having an inner surface and an outer surface, the outer cover molded to the torso shape of the mother animal;
a main bladder enclosed within the outer cover, the bladder holding a predetermined amount of liquid; and
at least one teat mounted to the outer surface of the cover, the at least one teat in fluid communication with the main bladder, the teat molded to the teat shape of the mother animal;
wherein upon the main bladder being filled with the liquid, the main bladder expands against the inner surface of the outer cover causing the outer cover to expand to a maximum expansion size;
wherein upon the liquid emptying from the main bladder, the main bladder contracts allowing the outer cover to contract to a minimum contraction size; and
wherein the outer cover maintains the torso shape of the mother animal at both the maximum expansion size and the minimum contraction size.

2. The animal nursing system of claim 1 wherein the outer cover is constructed from a firm, yet resilient, soft material.

3. The animal nursing system of claim 1 wherein the outer cover has dimensions similar to each particular species and breed,

4. The animal nursing system of claim 1 wherein the liquid is animal's milk, milk substitute, or other liquid nutritional supplements.

5. The animal nursing system of claim 1 wherein the main bladder is able to contract away from the inner surface of the outer cover when the outer cover reaches the minimum contraction size.

5. The animal nursing system of claim 1 and further comprising:
a plurality of spaced teats, each of the teats fluidly connected to the main bladder:
wherein the teats are divided between a top row and a bottom row.

7. The animal nursing system of claim 1 wherein the at least one teat is a replaceable nipple dispenser.

8. The animal nursing system of claim 7 and further comprising:
a vented rubber stopper to inhibit leaking.

9. The animal nursing system of claim 1 and further comprising:
at least one top fill port; and
a cap threadably securable to the top fill port;
wherein the top fill port is connected to the main bladder through the outer cover.

10. The animal nursing system of claim 9 wherein the top fill port is vented.

11. The animal nursing system of claim 1 and further comprising:
a baffle mechanism within the main bladder for controlling and regulating the flow of liquid through the main bladder and the teats.

12. The animal nursing system of claim 11 and further comprising:
a plurality of sub bladders formed in the main bladder, a single sub bladder associated with a single teat with the baffle mechanism controlling the flow to each sub bladder.

13. The animal nursing system of claim 12 wherein as the liquid removed from each sub bladder through the respective teat, no additional liquid is available to flow through the respective teat until the bladder is refilled.

14. The animal nursing system of claim 1 and further comprising:
a base unit releasably securable to the outer cover to maintain the outer cover in an upright position.

15. The animal nursing system of claim 1 and further comprising:
a closable pouch formed on the outer surface of the outer cover; and
a heating pad positionable in the pouch;
wherein the heating pad is capable of heating the liquid within the main bladder and the outer surface of the outer cover.

16. A method for feeding orphaned baby animals the baby animals being a particular species and breed, each particular species and breed having a mother animal with a particular torso shape and a particular teat shape, the method comprising:
providing an outer cover having an inner surface and an outer surface:
molding the outer cover to the torso shape of the mother animal, enclosing a main bladder within the outer cover;
filling the bladder with a predetermined amount of liquid;
mounting at least one teat to the outer surface of the cover;
molding the teat to the teat shape of the mother animal;
fluidly communicating the at least one teat with the main bladder;
expanding the main bladder against the inner surface of the outer cover causing the outer cover to expand to a maximum expansion size;
contracting the main bladder allowing the outer over to contract to a minimum contraction size; and
maintaining the outer cover in the torso shape of the mother animal at both the maximum expansion size and the minimum contraction size.

17. An animal nursing system for feeding orphaned baby animals, the baby animals being a particular species and breed, each particular species and breed having a mother animal with a particular torso shape and a particular teat shape, the animal nursing system comprising:
an outer cover having an inner surface and an outer surface, the outer cover molded to the torso shape of the mother animal;
a main bladder enclosed within the outer cover, the bladder holding a predetermined amount of liquid;
at least one teat mounted to the outer surface of the cover, the at least one teat in fluid communication with the rein bladder, the teat molded to the teat shape of the mother animal;
a closable pouch formed on the outer surface of the outer cover; and
a heating pad positionable in the pouch;
wherein the heating pad is capable of heating the liquid within the main bladder and the outer surface of the outer cover:
wherein upon the main bladder being filled with the liquid, the bladder expands against the inner surface of the outer cover causing the outer cover to also expand to a maximum expansion size;
wherein upon the liquid emptying from the bladder, the bladder contracts allowing the outer cover to contract to a minimum contraction size;
wherein the main bladder is able to contract away from the inner surface of the outer cover when the outer cover reaches the minimum contraction size; and
wherein the outer cover maintains the torso shape of the mother animal at both the maximum expansion size and the minimum contraction size.

18. The animal nursing system of claim 17 and further comprising:
a plurality of spaced teats, each of the teats fluidly connected to the main bladder;
wherein the teats are divided between a top row and a bottom row.

19. The animal nursing system of claim 17 and further comprising:
at least one top fill port; and
a cap threadably securable to the top fill port:
wherein the top fill port is connected to the main bladder through the outer cover.

20. The animal nursing system of claim 1 and further comprising:
a baffle mechanism within the main bladder for controlling and regulating the flow of liquid through the main bladder and the teats; and
a plurality of sub bladders formed in the main bladder, a single sub bladder associated with a single teat with the baffle mechanism controlling the flow to each sub bladder;
wherein as the liquid is removed from each sub bladder through the respective teat, no additional liquid is available to flow through the respective teat until the bladder is refilled.
